(19) United States
(12) Patent Application Publication
(10) Pub. No.: US 2024/0113303 A1
(43) Pub. Date: Apr. 4, 2024

(54) PROTECTIVE COATINGS ON SILICON ANODES FOR EFFECTIVE MANAGEMENT IN HIGH VOLUME CELL PLANT

(71) Applicant: GM GLOAL TECHNOLOGY OPERATIONS LLC, Detroit, MI (US)

(72) Inventors: Wai Ping Gloria Tam, Troy, MI (US); Xingcheng Xiao, Troy, MI (US)

(73) Assignee: GM GLOBAL TECHNOLOGY OPERATIONS LLC, Detroit, MI (US)

(21) Appl. No.: 17/959,496

(22) Filed: Oct. 4, 2022

(51) Int. Cl. H01M 4/62; H01M 4/04; H01M 4/38; H01M 10/0525

(52) U.S. Cl. CPC H01M 4/628; H01M 4/0428; H01M 4/0435; H01M 4/386; H01M 10/0525; H01M 2004/027

(57) ABSTRACT

Presented are silicon and other anodes and methods for producing same. In one aspect of the disclosure, a pristine anode material is prelithiated to produce a prelithiated anode substrate. Precursors are combined, such as using a flow into a deposition chamber, to produce a target chemical formulation formed as a hydrophobic and hermetic protective coating over the prelithiated Si-anode substrate. The result is a protected anode substrate. A laser may thereafter be used for further processing of the protected the protected anode substrate to form an anode. In other embodiments, a silicon oxide anode, a graphite anode, or a silicon-graphite blended anode is used.

### INTRODUCTION

The present disclosure relates generally to lithium-ion batteries. More specifically, aspects of this disclosure relate to anode handling in high volume manufacturing.

Lithium-ion batteries are a robust style of rechargeable batteries that have a high energy density and an ability to undergo numerous successive charge and discharge cycles. As a result, Li ion batteries are becoming increasingly popular, and consequently increasingly prevalent, in applications ranging from consumer electronics to different transport mechanisms (e.g., vehicles, trucks, boats, aircraft, spacecraft, etc.). Li ion batteries may be configured in a variety of different geometries using diverse chemical formulations, depending on factors like the application and design goals of the manufacturer.

The popularity of Li ion batteries has given rise to numerous high-volume battery cell manufacturing plants for producing the cells and accompanying electrodes. These electrodes typically include the graphite-based anode. A silicon (Si)-based anode has gained popularity due in large part to the high specific capacity of Si to store a large amount of Li ions upon charging. Si-anode host material such as lithium-silicide (LixSi) is frequently prelithiated in a chemically pristine form to help ensure a low-volume fluctuation of Si between cycles, and an adequate presence of Li ion in the resulting anode to compensate the Li loss during first few cycles. This prelithiated pristine anode material is reactive and subject to exothermic reactions with air and moisture. Thus, particularly in a high-volume plant involving activities and operators with different ongoing processes, care should be taken to ensure acceptable conditions to preserve the anode material such that dry-room conditions stay within relative humidity (RH) specifications to avoid undesirable chemical reactions and maintain an incident free-environment in high-volume plants.

### SUMMARY

These shortcomings in the art may be overcome using the principles described in this disclosure. Li ion batteries and techniques for making anodes are disclosed. In one aspect of the disclosure, a method for manufacturing an anode includes prelithiating a pristine anode material to produce a prelithiated anode substrate. Precursors are combined to produce a target chemical formulation, which forms as a hydrophobic protective coating over the prelithiated anode substrate to thereby produce a protected anode substrate. The protected anode may thereafter be processed safely downstream, e.g., using a laser to notch the anode for use in the Li ion battery.

A silicon (Si)-based anode, a silicon oxide-based anode, a corresponding silicon-graphite blended anode, a corresponding silicon oxide-graphite blended anode and others, have gained popularity due in large part to the high specific capacity of Si to store a large amount of Li ions upon charging.

In an aspect of the present disclosure, a method for manufacturing an anode is disclosed. The method includes prelithiating a pristine anode material to produce a prelithiated anode substrate. Thereupon, precursors are combined to produce a target chemical formulation for forming a hydrophobic and hermetic protective coating over the prelithiated anode substrate and thereby yield a protected anode substrate. The protected anode substrate may then be laser-notched to form the anode.

In some embodiments, the prelithiated Si-anode substrate includes lithium silicide (LiₓSi). The protective coating may be formed over the prelithiated Si-anode substrate from the target chemical formulation using atomic layer deposition (ALD) or molecular layer deposition (MLD). The ALD or MLD may include roll-to-roll ALD/MLD using a vacuum deposition chamber. The method may further include unrolling the pristine prelithiated Si-anode substrate into the vacuum deposition chamber. The method may also include monitoring, during the deposition of the protective coating, a desired thickness of the protective coating to avoid the reaction with air and moisture. The anode material may then be laser-notched to form the anode.

In some embodiments, the precursors comprise at least one of a fluoro-based monomer; a lithium-based precursor including lithium-fluoride (LiF) or lithium-tert butoxide; a Polytetrafluoroethylene (PTFE) monomer including Tetrafluoroethylene (C₂F₄); a Polyvinylidene difluoride (PVDF) monomer including Vinylidene-difluoride; Trimethyl-aluminum (TMA); Hydrogen-fluoride; Titanium-tetrafluoride; Aluminum-chloride; or Trimethyl-phosphate (TMP).

In some embodiments, the target chemical formulation is selected from a group consisting of Lithium-Fluoride (LiF); Aluminum Fluoride (AlF₃); Lithium Phosphate (Li₃PO₄); Aluminum Oxide (Al₂O₃), PVDF (Polyvinylidene difluoride); or PTFE (polytetrafluoroethylene).

The protective coating may be configured to reduce a relative humidity (RH) requirement in a dry room in which the Si-anode material is processed. The protective coating may be configured to prevent exothermic chemical reactions between the protected Si-anode substrate and at least one of H₂O, O₂, or N₂.

In another aspect of the disclosure, a method for manufacturing a silicon (Si) anode includes prelithiating a pristine Si-anode material to produce a prelithiated Si-anode substrate, unrolling the Si-anode substrate into a roll-to-roll (R2R) vacuum deposition chamber, evacuating air in the chamber to a target level, pulsing precursors alternatively into the chamber to produce a target chemical formulation that forms a hydrophobic protective coating over the Si-anode substrate, and removing the Si-anode substrate including the protective coating from the chamber.

In some embodiments, removing the Si-anode substrate includes rolling the Si-anode substrate including the protective coating from the chamber. The method may further include processing the Si-anode substrate including the protective coating using a laser. In various embodiments, the target chemical formulation is produced using atomic or molecular based deposition.

In some embodiments, the method may further include pumping the vacuum deposition chamber to a required vacuum level prior to pulsing the precursors. Pulsing the precursors may further include causing the precursors to enter the chamber via a carry gas flow, such as an inert gas, using high-speed valves. In other embodiments, the method may further include exposing the pulsed precursors to the Si-anode substrate for a desired exposure time prior to evacuating the residual precursors and byproducts from the chamber. The precursors may include at least one of a fluoro-based monomer; a lithium-based precursor including lithium-fluoride (LiF) or lithium-tert butoxide; a Polytetrafluoroethylene (PTFE) monomer including Tetrafluoroethylene (C₂F₄); a Polyvinylidene difluoride (PVDF) monomer including Vinylidene-difluoride; Trimethyl-aluminum (TMA); Hydrogen-fluoride; Titanium-tetrafluoride; Aluminum-chloride; or Trimethyl-phosphate (TMP).

The target chemical formulation may be selected from a group consisting of Lithium-Fluoride (LiF); Aluminum Fluoride (AlF₃); Lithium Phosphate (Li₃PO₄); Aluminum Oxide (Al₂O₃), PVDF (Polyvinylidene difluoride); or PTFE (polytetrafluoroethylene), or the combination of some of the chemical formulations.

In yet another aspect of the disclosure, a silicon (Si) anode for a lithium-ion battery includes a Si-anode substrate, a layer of a prelithiated pristine Si-anode substrate; and a protective coating formed over the substrate, the protective coating including a target chemical formulation selected from a group consisting of Lithium-Fluoride (LiF); Aluminum Fluoride (AlF₃); Lithium Phosphate (Li₃PO₄); Aluminum Oxide (Al₂O₃), PVDF (Polyvinylidene difluoride); or PTFE (polytetrafluoroethylene).

The above Summary is not intended to represent every embodiment or every aspect of the present disclosure. Rather, the foregoing summary merely provides an exemplification of some of the novel concepts and features set forth herein. The above features and advantages, and other features and attendant advantages of this disclosure, will be readily apparent from the following detailed description of illustrated examples and representative modes for carrying out the present disclosure when taken in connection with the accompanying drawings and the appended claims. Moreover, this disclosure expressly includes the various combinations and sub combinations of the elements and features presented above and below.

### BRIEF DESCRIPTION OF THE DRAWINGS

FIG. 1 is a side-view illustration of various example components of a representative Li ion battery according to aspects of the disclosure.

FIG. 2 is a pouch cell representation of a Li ion battery according to aspects of the disclosure.

FIG. 3 is a top-view, conceptual diagram of a pristine prelithiated Si-anode material being notched via a laser and exothermic reactions that can take place upon application of the laser.

FIG. 4 is a top-view, conceptual diagram of a pristine prelithiated Si-anode substrate having formed thereon a protective coating prior to being processed further downstream, according to aspects of the disclosure.

FIG. 5 is a side-view illustration of an example roll-to-roll atomic layer deposition or molecular layer deposition (ALD/MLD) process using a vacuum deposition chamber according to aspects of the disclosure.

FIG. 6 is a formulaic view of different precursor fluoropolymer precursors that may be used in a chemical ALD/MLD technique for manufacturing Si-anodes by applying the fluoropolymer to produce a Si-anode substrate having a solid electrolyte interface (SEI) layer and defluorinating the precursors.

FIG. 7 is a conceptual flow diagram of a process for manufacturing a Si-Anode ready for downstream assembly.

FIG. 8 is a flow diagram illustrating a process for forming a protective coating on a Si-anode substrate according to various aspects of the disclosure.

The present disclosure is amenable to various modifications and alternative forms, and some representative embodiments are shown by way of example in the drawings and will be described in detail herein. It should be understood, however, that the novel aspects of this disclosure are not limited to the forms illustrated in the above-enumerated drawings. Rather, the disclosure is to cover all modifications, equivalents, combinations, sub combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, and Detailed Description sections, but not explicitly set forth in the claims, should not be incorporated into the claims, singly or collectively, by implication, inference or otherwise.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein in the sense of “at, near, or nearly at,” or “within 0-5% of,” or “within acceptable manufacturing tolerances,” or any logical combination thereof, for example.

The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Presented herein are Li ion battery cells, anodes for use in same, and processes of manufacturing Si-anodes for Li ion battery cells used in various electric motor-driven and other consumer grade applications. As noted, existing solutions common to numerous types of Li ion battery cells give rise to stringent RH requirements to ensure that the reactivity of pristine prelithiated Si-anode host material does not spontaneously produce unwanted chemical reactions. Maintaining these and other stringent conditions on an ongoing basis presents a challenge, however, especially in high-volume cell plants. Aspects of the disclosure enable Li ion battery and electrode manufacturers to relax RH specifications in some configurations, and to provide increased manufacturing stability and confidence in energy management despite the reactive nature of the pertinent components.

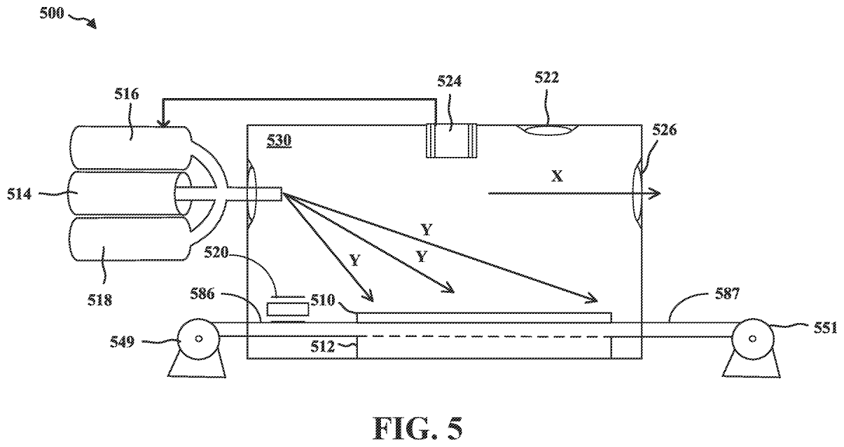

An increasing number of anodes in Li ion batteries are made using silicon to store lithium ions, in lieu of the existing anodes, the latter of which are formed using graphite to store the lithium ions. Silicon has the advantage of being more plentiful and being able to store more lithium ions at the anode due to its high specific capacity, thus according the Li ion battery cell a higher energy density. Accordingly, in many examples throughout this specification, Si-anodes or silicon-based anodes are referenced in different embodiments. However, the principles of the present disclosure apply with equal force to other types of electrodes. Thus, in these embodiments in which silicon anodes are identified, corresponding embodiments may exist in which graphite can be used as the mechanism for intercalation of lithium ions. In other embodiments, manufacturers may opt to blend graphite with silicon in order to use an anode substance that takes advantage of both blends. As such, for purposes of this disclosure, the anode can be made of one or more of these substances, including a blend of graphite and silicon, without departing from the scope of the disclosure. It will be appreciated that, where different chemicals are used to form the anode, these different chemicals may also entail the use of different precursors (or different amounts of a given precursor) and a different target chemical formulation. To accommodate different chemicals used at the anodes, or different relative proportions of such chemicals, the development of the protective layer may be different. That is, different pulse rates, temperatures, thicknesses of the protective coatings, and other factors may accordingly be used in the ALD/MLD processes (FIG. 5) depending on whether the anode is a Si-anode, an anode using silicon oxide, an anode using graphite, or some mixture thereof.

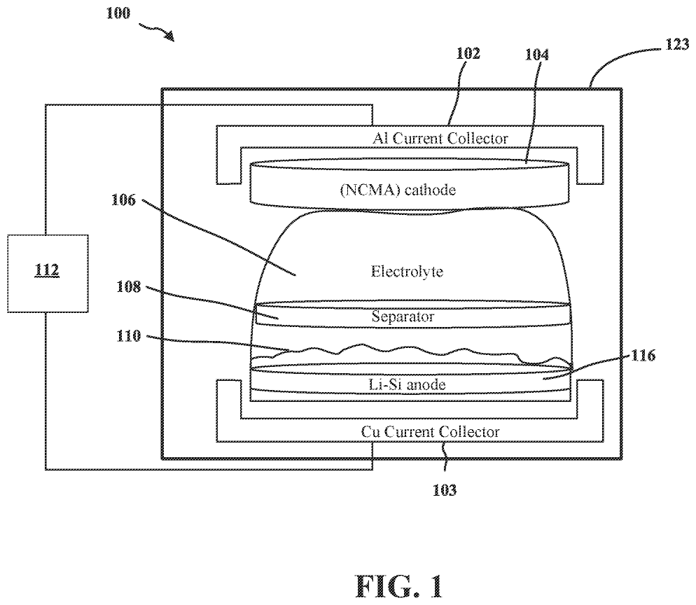

Loss of lithium in the initial cycles appreciably reduces the energy density of lithium-ion batteries. Various types of prelithiation techniques exist that compensate for this reduced energy density. Chemical prelithiation refers to the use of a lithium-containing reagent with a strong reducing strength to transfer the active lithium to the anode material by the redox reaction. Prelithiation, whether chemical or otherwise, compensates for the lithium loss due to the formation of a solid electrolyte interface (SEI) layer (FIG. 1) during the initial charge and during long term cycling can be compensated. Silicon-based anodes have a high specific capacity for storing of Lithium ions. Significant changes in volume of the silicon together with side reactions with electrolytes cause lithium loss and a lower coulombic efficiency of Si-anodes. The various prelithiation techniques may be used to counter these adverse effects.

Referring to the drawings, wherein like reference numbers refer to like features to provide representative embodiments for typical applications throughout the several views, FIG. 1 depicts a side-view illustration of various example components of a representative Li ion battery cell 100 according to aspects of the disclosure. The Li ion battery cell 100 may be coupled to a load 112, which may act as an interruptible external circuit. The load 112 may act as voltage source when the Li ion battery cell 100 is charging. The load 112 may represent, for example, a set of circuits such as electronics in a mobile device when the Li ion battery cell 100 is discharging, such as when the Li ion battery cell 100 is being used to power the mobile device 112. The load 112 may represent a turning motor shaft when the Li ion battery cell 100 or array thereof is implemented in a vehicle. In these circumstances, the load may represent an external battery charging device, such as when the electric vehicle (EV) is being charged or the force from application of the brakes is used to generate electricity.

The Li ion basic components of the anode may include a Lithium Si-anode 116, such as lithium silicide (LiₓSi) which may be sandwiched between a copper (Cu) current collector 103 and a solid electrolyte interface (SEI) layer 110 that was formed during the initial charging process. The SEI layer uses a certain percentage of the Lithium ions. On the cathode side of the Li ion battery cell, an aluminum (Al) current collector may be coupled to a cathode 104, such as a nickel cobalt manganese Aluminum (NCMA) cathode, for example. The aluminum current collector 102 and the copper current collector 103 associated with the two electrodes are connected by the load 112 that allows an electric current to pass between the electrodes to electrically balance the related migration of lithium ions. Between the cathode 104 and the SEI layer 110 is an electrolyte 106 for allowing the Lithium ions to transport back and forth during charging and discharging cycles. The electrolyte 106 may be a liquid electrolyte including one or more lithium salts dissolved in a non-aqueous solvent. A separator 108 is further included between the anode and cathode to prevent a short circuit between the cathode and the anode. The anode 116, cathode 104 and electrolyte 106 can be encapsulated in a container 123, which can be a hard (e.g., metallic) case or a soft (e.g., polymer) pouch, for example. The container 123 may have a cylindrical shape in cases where the battery components are rolled up into a cylinder. In other embodiments, the container 123 may include a hard or soft pouch with a rectangular cross section where the battery components lay flat for about the container length and then are folded one or more times. Still other configurations for the container 123 are possible.

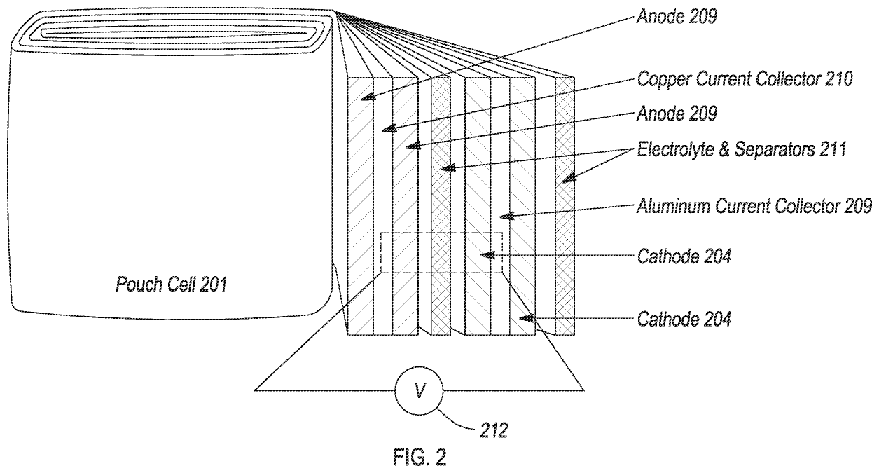

FIG. 2 is a pouch cell representation of a Li ion battery according to aspects of the disclosure. A pouch cell 201 is a battery design where most of the cell components are enclosed in an aluminum-coated plastic film. Only two tabs stick out, each welded to current collectors in the pouch. These highly conductive tabs carry out the positive and negative connector tabs and allow to get the electric energy out of the pouch cell. In pouch cell configurations, the electrode material can be typically found on both sides of a current collector.

With reference to FIG. 2, the pouch cell 201 includes a plurality of folded sections. These include a copper current collector 210. On either side of the copper current collector is a region of the anode 209. To the right of anode 209 is a region for the electrolyte and a separator 211. A first portion of cathode 204 is shown to the right of the electrolyte/separator 211, followed by an aluminum current collector 209. Another region of the cathode 204 is shown to the right of the aluminum current collector 209. Each of these materials are folded around one or more times within the pouch cell. In different embodiments, a different number of layers may be used. Tabs (not shown) may be connected to respective cathode and anode regions at the end to provide electrical conductivity.

Shown across the inner cathode 204 and inner anode 209 is a potential difference V 212 that may be created by the potential energy difference created across the cathode 204 and anode 209 when the pouch cell 201 is charged. The voltage V 212 can be used as a power source to drive an external device, such as an electric vehicle (EV) or other mechanized assembly.

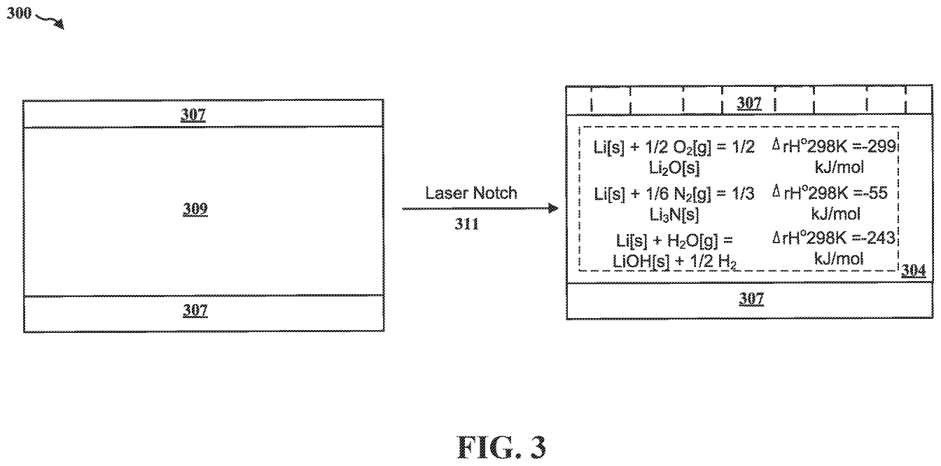

As noted, the high reactivity of prelithiated Si-anode material means that the manufacturing of a prelithiated Si-anode in a high-volume cell plant gives rise to possible damage-related incidents that may occur as a result of spontaneous exothermic reactions. FIG. 3 is a top-view, conceptual diagram 300 of a pristine prelithiated Si-anode material being notched via a laser and exothermic reactions that can take place upon application of the laser. A region of pristine Si-anode material is prelithiated to form a pristine prelithiated Si-anode substrate 309. In the example shown, the pristine prelithiated Si-anode substrate 309 includes border regions 307 that are used to feed the pristine prelithiated Si-anode substrate 309 on a roller as it passes through various processing steps.

After the pristine prelithiated Si-anode substrate 309 is formed, it may then be subjected to a laser notch 311 in which one or more lasers perform cutting and/or notching of the pristine prelithiated Si-anode substrate 309 to form Si-anode 204. For purposes of this disclosure, the Si-anode 304 may not be the completed anode, but rather may be subjected to further downstream processing. It will be appreciated that Si-anode 304 is not necessarily drawn to scale, and there may be more than one anode 304 for one pristine prelithiated Si-anode substrate 309. Also, in other embodiments, silicon oxide, graphite or a silicon/graphite based anode substrate may be used. The term “substrate” may be used to refer to more than one anode, which may be subsequently laser-notched or otherwise cut into separate anode or for additional or different reasons.

In other embodiments, in addition to comprising a silicon-based anode substrate 309, the substrate may instead include a graphite-based anode substrate, or a silicon-graphite blended anode substrate.

The existing manufacturing steps are such that the Lithium in the unprotected prelithiated Si-anode substrate can potentially react exothermally with moisture, O₂ and N₂ that may be present, albeit residually, from the dry room atmosphere. This potential for exothermic reactions can increase the risk of damage due to the energy release. Referring back to FIG. 3, the prelithiated Si-anode 304 identifies three such chemical reactions that can spontaneously occur during the existing manufacturing process described with reference to FIG. 3. In one such reaction, lithium in solid form can react with the diatomic gaseous molecule oxygen to produce Li₂O in solid form. An exothermic release of energy in the reaction at 298K is 299 KJ/mol. Similarly, solid lithium can react with the gaseous molecule nitrogen to produce Li₃N in solid form, thereby releasing 55 KJ/mol at the same temperature. Solid lithium can also react with water vapor to release 243 KJ/mol at 298K.

The risk of an incident may increase in a high-volume cell plant, where significant activity may be occurring, and it may be further difficult to meet the stringent requirements of relative humidity (RH). These factors, combined with the high reactivity of Lithium and in some cases the presence of heat-producing laser notch 211, can result in unintended damage-producing chemical reactions.

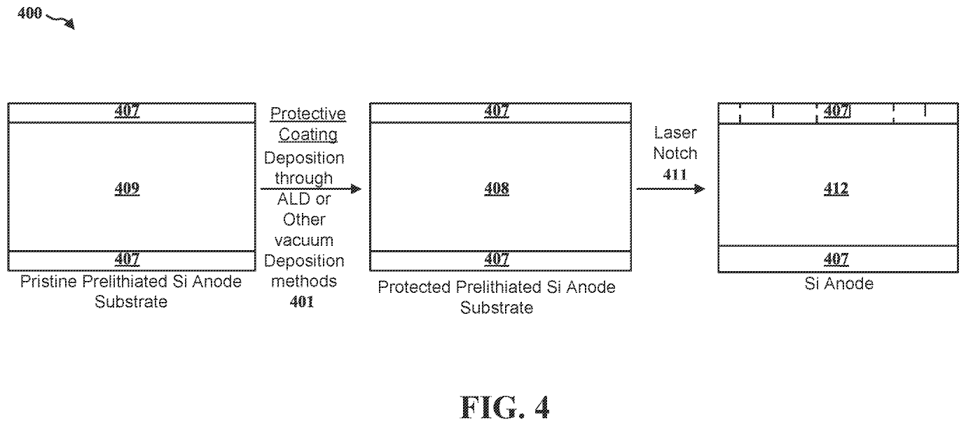

FIG. 4 is a top-view, conceptual diagram 400 of a pristine prelithiated Si-anode substrate having formed thereon a protective coating prior to being processed further downstream, according to aspects of the disclosure. As before, pristine Si-anode material is prelithiated to form a pristine prelithiated Si-anode substrate 409. However, unlike the existing process and prior to exposure to laser notch 411, a protective coating at 401 is deposited onto the pristine prelithiated Si-anode substrate 409 to produce a protected prelithiated Si-anode substrate 408. While the protective coating may be deposited using a number of different deposition methods, in an embodiment, the protective coating may be deposited using atomic layer deposition (ALD) or molecular layer deposition (MLD). In various embodiments, a roll-to-roll (R2R) technique may be implemented in which the Si-anode material or substrate is unrolled from a first roller to enter into a vacuum deposition chamber. After the material or anode is processed, the material/anode is removed from the vacuum deposition chamber by being rolled onto a second roller. The material may then be subjected to further downstream processes (e.g., use of laser notch 411 to form prelithiated Si-anode 412) without the risk of damage. The side regions 407 may be used for the rolling procedure.

In short, the protective coating deposited onto the pristine prelithiated Si-anode substrate protects the substrate from exposure to moisture, O₂ and N₂ that may be present in the dry room atmosphere. This degree of protection has advantages. First, the protective coating dramatically increases safe handling of the protected prelithiated Si-anode substrate 409, particularly during downstream processes that generate heat (e.g., lasers) or that expose the protected prelithiated Si-anode substrate 409 to one of the chemicals with which Li reacts exothermally. Second, the presence of a protective layer formed on protected prelithiated Si-anode substrate may enable manufacturers to impose potentially less stringent RH specifications at high volume cell plants, which can decrease cost significantly while increasing reliability and overall robustness.

The potential damage concern related to the prelithiated Si-anode substrate handling in a high-volume cell plant is therefore alleviated by applying a surface coating on the prelithiated Si-anode substrate after the prelithiation process to prevent chemical reactions with moisture, O₂ and N₂ from the atmosphere during cell manufacturing. In various embodiments as noted, the deposition process for applying the protective coating is performed by using R2R ALD or MLD. For example, in some embodiments, certain fluoro-based monomers can be used as precursors that, upon injection into the vacuum deposition chamber and the requisite chemical reactions, may cause a target chemical formulation, such as, for example, LiF+(carbon nature matrix). This target chemical formulation is used as the protective coating. The protective coating is hydrophobic, and as such it can effectively prevent a chemical reaction with moisture. Further, as described below, the target chemical formula may have pinhole-free characteristics, which prevents exposure of the Lithium to O₂ and N₂ and thus prevents exothermic reactions involving these molecules. In addition, other target chemical formulations can be applied as well, including but not limited to ALF₃ and Li₃PO₄.

FIG. 5 is a side-view illustration 500 of an example roll-to-roll atomic layer deposition or molecular layer deposition (ALD/MLD) process using a vacuum deposition chamber according to aspects of the disclosure. In this example, the vacuum deposition chamber 530 is coupled at the left side to precursor containers 516 and 518, each container storing a specific precursor. While two precursor containers are illustrated, a different number of precursors may be used in various embodiments, and thus additional containers may be included. In some embodiments, a single precursor container may include a blend of two or more precursors. Also shown adjacent the precursor containers 516 and 518 is a reservoir 514 that includes an inert gas, also known as a carry gas (e.g., Argon), that in some embodiments is used to receive the precursors from containers 516 and 518 and to carry the combined precursors into the vacuum deposition chamber 530, where a chemical reaction occurs to form a target chemical formulation identified by the reference “Y” and the three arrows.

Further shown in FIG. 5 is a first roller 549 (e.g., for rolling a prelithiated Si-anode substrate 586 into the vacuum deposition chamber) and a second roller 551 (e.g., for rolling from the chamber the combined protected prelithiated Si-anode substrate out of the chamber for use in further downstream processing. In the embodiment shown, platform 512 is used to stabilize the prelithiated Si-anode substrate 586 as it enters the vacuum deposition chamber 530. As noted, the chemical reaction using the precursors produces the target chemical formulation “Y” which is deposited onto the substrate 586 as protective coating 510 (thereby producing the combined protected prelithiated Si-anode substrate 587).

Referring still to FIG. 5, temperature unit 524 may be used in the vacuum deposition chamber 530 to regulate both the temperature within the vacuum deposition chamber 530 and the individual temperatures of the precursors for the desired chemical reaction. As one of several examples in which a protective coating is deposited, one such target chemical formulation is lithium phosphate (Li₃PO₄). Container 516 may be used to store precursor trimethyl phosphate (TMP, or (CH₃)₃PO₄), and container 518 can be used to store lithium tert-butoxide (LiO^{t}Bu or (CH₃)₃COLi). The temperature unit 524 can set the heating temperature for TMP at about 80 degrees Celsius, and for LiO^{t}Bu at about 160 degrees Celsius. The temperature unit can set the deposition temperature for the Li₃PO₄ at about 160 degrees Celsius. The vacuum deposition chamber may also include an oscillator or other component 520 for monitoring the thickness of the protective coating, which may be controlled by the cycle number or an oscillator frequency. The pulse for each precursor in this example is set to be about 0.1 seconds. The chemical reaction that takes place between the precursors to produce the target chemical formulation is:

3(CH₃)₃COLi+(CH₃)₃PO₄═Li₃PO₄+9CH₄+3CO

The vacuum deposition chamber further includes a vent 522, which may be used to empty air from the vacuum deposition chamber 530 and approach vacuum conditions. In addition, valve 526 may be used to expel byproducts of the chemical reaction, as shown by the reference “X” and related arrow flowing through valve 526.

In addition to the above target chemical formulation, a number of other chemical formulations may be used, each of which may rely on different precursors. Certain examples include the following list of target chemical formulations (identified by the leftmost name) and chemical reaction equations.
1. PTFE—polytetrafluoroethylene (C₂F₄)n:

(C₂F₄)n+4nLi=4nLiF+(C—C)n
2. PVDF—Polyvinylidene fluoride (C₂H₂F₂)n:

(C₂H₂F₂)n+2nLi=2nLiF+(C₂H₂)n
3. Aluminum Fluoride (AlF₃):

Al(CH₃)₃+HF=AlF₃+CH₄ or 4AlCl₃+3TiF₄=4AlF₃+3TiCl₄
4. Aluminum Oxide (Al₂O₃):

2Al(CH₃)₃+3H₂O═Al₂O₃+6CH₄

While the above list represents exemplary target chemical formulations and precursors, the list is not intended to be exhaustive, and other target chemical formulations for providing a hydrophobic protective coating are possible. With reference to the above examples, the precursors may differ depending on the target chemical formulation desired and may include a fluoro-based monomer; a lithium-based precursor including lithium-fluoride (LiF) or lithium-tert butoxide; a Polytetrafluoroethylene (PTFE) monomer including Tetrafluoroethylene (C₂F₄); a Polyvinylidene difluoride (PVDF) monomer including Vinylidene-difluoride; Trimethyl-aluminum (TMA); Hydrogen-fluoride; Titanium-tetrafluoride; Aluminum-chloride; or Trimethyl-phosphate (TMP). The target chemical formulations include one of Lithium-Fluoride (LiF); Aluminum Fluoride (AlF₃); Lithium Phosphate (Li₃PO₄); Aluminum Oxide (Al₂O₃), PVDF (Polyvinylidene difluoride); or PTFE (polytetrafluoroethylene). The list is not exhaustive, and other target chemical formulations may be used that have the hydrophobic properties and that protect the prelithiated Si-anode substrate from reacting with diatomic molecules in the air, including O₂ and N₂.

Silicon-based anodes are better solutions than existing anodes using graphite because of their capacity to store many more lithium ions. With respect to the latter, physical layer deposition (in lieu of chemical deposition) may be used in the process of defluorination. Defluorination in existing Lithium electrodes may involve lending mechanical protection to the lithium anodes. The techniques, as noted, rely on physical layer deposition (instead of ALD/MLD, which are chemical layer deposition processes) to deposit the fluoropolymers and direct contact between the fluoropolymer and lithium host material along with heat, to produce defluorination.

In the present disclosure involving Si-anodes, silicon is a highly porous material. Thus, physical deposition of fluoropolymers tends to leave the coating porous, meaning that the surface of the prelithiated Si-anode substrate is not completely protected from exothermic reactions. However, the defluorination process may be performed in the context of Si-anodes using chemical-based ALD or MLD. Using chemical deposition, the manufacturer can control all the different polymer species so that they penetrate the pores and extend deep into the electrode material. In this case, even if the top layer is exposed to air or moisture, unwanted exothermic reactions may be avoided. Another difference with Si-anode substrates is that besides fluoropolymers, various oxides, nitrides, and other ionic conducting materials may also be used. Still other precursors may be used as limiting reagents, as well as using specific pressures, temperatures, and processing times. These additional materials are deemed to fall within the spirit and scope of the present disclosure.

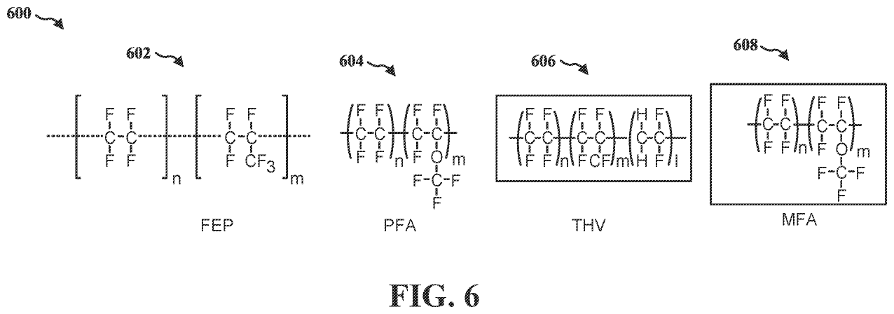

FIG. 6 is a formulaic view of different precursor fluoropolymer precursors 600 that may be used in a chemical atomic layer deposition/molecular layer deposition (ALD/MLD) technique for manufacturing Si-anodes by applying the fluoropolymer to produce a Si-anode substrate having a solid electrolyte interface (SEI) layer and defluorinating the precursors. In various embodiments, the precursors and subsequent defluorination are used as part of chemical-based ALD or MLD.

Exemplary precursors that may be used as part of this process is fluorinated ethylene propylene (FEP) 602, perfluoro alkoxy alkanes (PFA) 604, vinylidene fluoride (THV) 606, and copolymers of perfluoro methylvinylether and tetrafluoroethylene (MFA) 608. These precursors and other fluoro-based monomers may be used to produce a target chemical formulation including LiF and a carbon-nature matrix. In addition, various oxides and other ionic conducting materials may also be used as precursors.

The above-described target chemical formulations as well as the subsequently identified precursors in FIG. 6 have several advantages over existing techniques. For one, the surface coating is hydrophobic, which protects the prelithiated Si-anode substrate from reacting with water vapor/O₂/N₂ during downstream cell assembly processes, enabling controlled handling at a high-volume battery cell plant. Additionally, the protective surface coating may also serve as the artificial solid electrolyte interface (SEI) layer, which improves the cycle efficiency and extends the life of the Li ion battery. Another advantage is that the coating precursors react with lithiated silicon and form strong covalent bonding at the interface, which in turn avoids the coating delamination that otherwise may be caused by the volume change in the silicon during battery charging and discharging. Still another benefit of the principles of the present disclosure with respect to the R2R process is that this process may be scaled up and integrated seamlessly with an electrode/cell fabrication line.

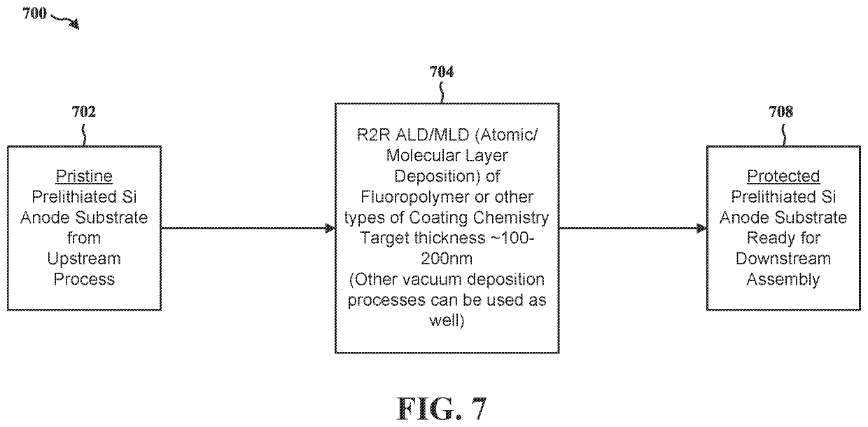

FIG. 7 is a conceptual flow diagram of a process 700 for manufacturing a Si-Anode ready for downstream assembly. The steps of FIG. 7 may be performed using a vacuum deposition chamber and an R2R ALD or MILD chemical deposition process, as described above. Other vacuum deposition processes may be used as well. The vacuum deposition chamber may be controlled by a controller, which may include one or more processors and a memory device. The processor(s) may be a general-purpose processor, reduced instruction set computer (RISC) processor, or similar processing device or controller running executable code, or firmware. In other embodiments, the processor(s) may be implemented in hardware, such as a field programmable gate array (FPGA) logic device, a digital signal processor (DSP), an application-specific integrated circuit (ASIC), or some other hardware, or hybrid hardware/software assembly.

Block 702 initially represents a pristine prelithiated Si-anode that was assembled initially during an upstream manufacturing process. Block 704 represents an R2R ALD/MLD chemical deposition device in which a deposition chamber is used to deposit a fluoropolymer or other type of target chemical formulation, as discussed above. In some embodiments, the target thickness identified by the number of cycles is set to be between about 100-200 nanometers (nm). In an embodiment, the thickness is monitored using a crystal monitor, such as component 520 in FIG. 5. Component 420 may represent a quartz crystal oscillator, which is present in the vacuum deposition chamber. One face of the crystal is exposed towards the deposition source. As material is deposited it also coats the crystal. As more material is deposited onto the crystal, thereby increasing a pressure against the oscillator, the frequency of oscillation increases. At a particular cycle count or frequency value, a target value can be determined. Other techniques, such as x-ray imaging, may be used to monitor thickness as well.

Block 708 represents the protected prelithiated Si-anode, which is now ready for further downstream assembly. For example, the Si-anodes may be cut from the substrate material using a laser, and without concerns of an exothermic reaction. Additional manipulation of the Si-anode, including further laser notching and assembly into a Li ion cell, may be conducted as part of the downstream process.

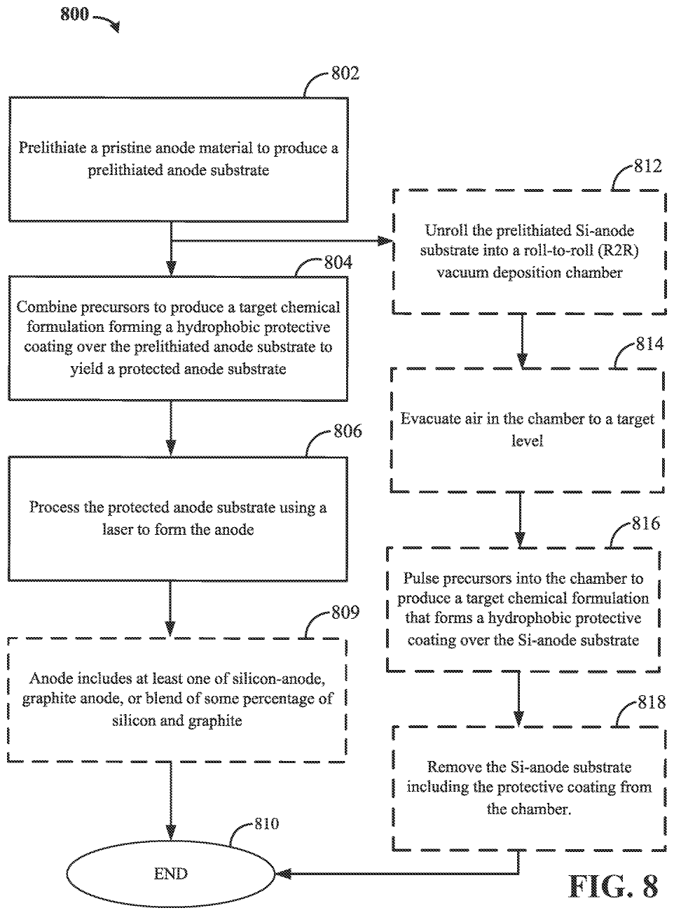

FIG. 8 is a flow diagram illustrating a process 800 for forming a protective coating on a Si-anode substrate according to various aspects of the disclosure. The various steps may be performed by the items identified above with reference to FIG. 7. In addition, the prelithiation may be performed during an upstream period in the process. For example, if chemical prelithiation is utilized, a lithium-containing reagent with a strong reducing strength (i.e., one that easily donates electrons) may be used in a controlled chemical reaction to transfer the active lithium to the pristine Si-anode material. Other types of prelithiation techniques may also be used. The boxes in FIG. 8 that are dashed represent optional steps.

Referring initially to step 802, a pristine Si-anode material may be unrolled or otherwise dispensed to enable the material to be prelithiated, such as in the chemical manner described above, to produce a prelithiated Si-anode substrate. At step 804, different precursors may be combined to produce a target chemical formulation forming a hydrophobic protective coating over the prelithiated Si-anode substrate. At step 806, the protected Si-anode substrate may be processed using a laser to form the Si-anode. Step 809 is an optional step wherein the Si-anode referenced in the chart, depending on the embodiment, may use silicon as part of the Si-anode, or in other embodiments and in lieu of silicon in FIG. 8, graphite may be used in lieu of silicon as part of the body. Finally, in still other embodiments, the node may instead include a blend of some percentage of silicon and graphite. The blend attempts to achieve the benefits of both silicon and graphite. The process ends at 810.

In some embodiments, after the prelithiation of step 802, the prelithiated Si-anode substrate is unrolled into a roll-to-roll (R2R) vacuum deposition chamber. At step 814, using the vent 422 (FIG. 4), the air in the vacuum deposition chamber is evacuated to a target level. Next, at step 816 and in a procedure similar to that of step 804, the precursors are pulsed into the chamber at a desired duration (e.g., 0.1 sec) to produce a target chemical formulation that forms a hydrophobic protective coating over the Si-anode substrate. Thereupon, at step 818, using a roller like second roller 551 (FIG. 5), the Si-anode substrate, now including the deposited protective coating, may be removed from the vacuum deposition chamber. The process ends at 810.

It should be understood that, even though the steps of FIG. 8 show a portion of the process in midstream, the further downstream processes that the protected Si-anode substrate is protected from include not only the laser-cutting of the individual Si-anodes, but also the downstream assembly of the Li ion battery cell. This includes steps that join the respective electrodes, including the anode and cathode, to the remaining portions of the cell (e.g., the electrolyte, separator, and the like) and the assembly of the cell into the appropriate container. The protected Si-anodes therefore stand to benefit not merely from the laser-cutting process, but also other downstream process that may otherwise expose the Si-anode to potential exothermic reactions in the absence of the protective coating.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed:

1. A method for manufacturing an anode, comprising:
prelithiating a pristine anode material to produce a prelithiated anode substrate;
combining precursors to produce a target chemical formulation that forms a hydrophobic protective coating over the prelithiated anode substrate to yield a protected Si-anode substrate; and
processing the protected anode substrate using a laser to form the anode.

2. The method of claim 1, wherein the prelithiated anode substrate comprises a silicon-based anode substrate, a silicon oxide based anode, a graphite-based anode substrate, or a blend thereof.

3. The method of claim 1, wherein the protective coating is formed over the prelithiated anode substrate from the target chemical formulation using atomic layer deposition (ALD), molecular layer deposition (MLD), or other chemical vapor deposition (CVD).

4. The method of claim 3, wherein the ALD or MLD comprises roll-to-roll ALD or roll-to-roll MLD using a vacuum deposition chamber.

5. The method of claim 4, further comprising unrolling the prelithiated anode substrate into the vacuum deposition chamber.

6. The method of claim 5, further comprising monitoring, during deposition of the protective coating, a thickness of the protective coating to achieve a desired thickness value for the protective coating.

7. The method of claim 1, wherein the precursors comprise at least one of a fluoro-based monomer; a lithium-based precursor including lithium-fluoride (LiF) or lithium-tert butoxide; a Polytetrafluoroethylene (PTFE) monomer including Tetrafluoroethylene (C₂F₄); a Polyvinylidene difluoride (PVDF) monomer including Vinylidene-difluoride; Trimethyl-aluminum (TMA); Hydrogen-fluoride; Titanium-tetrafluoride; Aluminum-chloride; or Trimethyl-phosphate (TMP).

8. The method of claim 1, wherein the target chemical formulation is selected from a group consisting of one or more of Lithium-Fluoride (LiF); Aluminum Fluoride (AlF₃); Lithium Phosphate (Li₃PO₄); Aluminum Oxide (Al₂O₃), PVDF (Polyvinylidene difluoride); or PTFE (polytetrafluoroethylene).

9. The method of claim 1, wherein the protective coating is configured to reduce a relative humidity (RH) requirement in a dry room in which the anode material is processed.

10. The method of claim 1, wherein the protective coating is configured to prevent exothermic chemical reactions between the protected Si-anode substrate and at least one of H₂O, O₂, or N₂.

11. A method for manufacturing an anode, comprising:
prelithiating a pristine anode material to produce a prelithiated anode substrate;
unrolling the prelithiated anode substrate into a roll-to-roll (R2R) vacuum deposition chamber;
evacuating air in the chamber to a desired level;
pulsing precursors into the chamber to produce a target chemical formulation that forms a hydrophobic protective coating over the prelithiated anode substrate; and
removing the anode substrate including the protective coating from the chamber,
wherein the prelithiated anode comprises a silicon-based substrate, a silicon oxide based substrate, a graphite-based substrate, or a blend thereof.

12. The method of claim 11, wherein removing the anode substrate comprises rolling the anode substrate including the protective coating from the chamber.

13. The method of claim 11, further comprising processing the anode substrate including the protective coating using a laser to form at least one anode.

14. The method of claim 11, wherein the target chemical formulation is produced using atomic or molecular based deposition.

15. The method of claim 11, further comprising pumping the vacuum deposition chamber to a required vacuum level prior to pulsing the precursors.

16. The method of claim 11, wherein pulsing the precursors further comprises causing the precursors to enter the chamber via a gas flow using high-speed valves.

17. The method of claim 16, further comprising exposing the pulsed precursors to the anode substrate for a desired exposure time prior to vacuuming the chamber.

18. The method of claim 11, wherein the precursors comprise at least one of a fluoro-based monomer; a lithium-based precursor including lithium-fluoride (LiF) or lithium-tert butoxide; a Polytetrafluoroethylene (PTFE) monomer including Tetrafluoroethylene (C₂F₄); a Polyvinylidene difluoride (PVDF) monomer including Vinylidene-difluoride; Trimethyl-aluminum (TMA); Hydrogen-fluoride; Titanium-tetrafluoride; Aluminum-chloride; or Trimethyl-phosphate (TMP).

19. The method of claim 11, wherein the target chemical formulation is selected from a group consisting of one or more of Lithium-Fluoride (LiF); Aluminum Fluoride (AlF₃); Lithium Phosphate (Li₃PO₄); Aluminum Oxide (Al₂O₃), PVDF (Polyvinylidene difluoride); or PTFE (polytetrafluoroethylene).

20. An anode for a lithium-ion battery, comprising:
an anode substrate comprising;
a layer of a prelithiated anode substrate; and
a protective coating formed over the substrate, the protective coating having a target chemical formulation selected from a group consisting of Lithium-Fluoride (LiF); Aluminum Fluoride (AlF₃); Lithium Phosphate (Li₃PO₄); Aluminum Oxide (Al₂O₃), PVDF (Polyvinylidene difluoride); or PTFE (polytetrafluoroethylene),
wherein the anode substrate comprises at least one of a silicon-based substrate, a silicon oxide based substrate, a graphite-based substrate, or a blend thereof.
